(19) United States
(12) Patent Application Publication
(10) Pub. No.: US 2026/0132042 A1
(43) Pub. Date: May 14, 2026

(54) PROCESS AND PLANT FOR A PERMANENT STORAGE OF PHOSPHOGYPSUM

(71) Applicant: METSO METALS OY, Espoo (FI)

(72) Inventors: Andreas ORTH, Oberursel (DE); Hannes STORCH, Friedrichsdorf (DE); Alessio SCARSELLA, Bad Homburg (DE); Joerg HAMMERSCHMIDT, Erlensee (DE); Karl-Heinz DAUM, Limburg (DE)

(21) Appl. No.: 19/118,156

(22) PCT Filed: Oct. 11, 2022
(86) PCT No.: PCT/FI2022/050676

§ 371 Date: Apr. 3, 2025

(51) Int. Cl. C01F 11/18; B01J 19/24

(52) U.S. Cl. CPC C01F 11/18; B01J 19/245; B01J 19/248

(57) ABSTRACT

A process and the related plant for the permanent deposition of phosphogypsum with simultaneous permanent carbon dioxide sequestration. This process includes a step (i) for decomposition calcium sulfate contained in the phosphogypsum with hydrogen to calcium oxide, sulfur dioxide and water at temperatures between 1.00° and 1.400° C. Thereby, a gas stream containing the sulfur dioxide and the water and a solid stream containing the produced calcium oxide result. In a further step (ii), production of sulfuric acid takes place by converting the sulfur dioxide contained in the gas stream obtained in step (i) to the acid. In step (iii), the calcium oxide contained in the solid stream is carbonized with carbon dioxide to a calcium carbonate at temperatures between 50° and 800° C. to obtain a solid material. Finally, the solid material obtained in step (iii) is deposited in a last step (iv).

The question of the ecological footprint is becoming increasingly important for all processes. Consequently, the question of residues and their ecological compatibility and usage for further generations as raw material source is becoming increasingly important. Moreover, on the one hand, this also concerns the energy consumption of a process to use residues for saving fossil fuel; on the other hand, it should cover the minimizing of CO₂ emissions, too.

In this context, the fertilizer industry plays an often-underestimated role. With intensive agricultural land use, it is necessary to supply especially the elements nitrogen, potassium, phosphorus, and calcium to the soil in the form of fertilizers, in a sustainable way.

The phosphate fertilizer industry is at present based mainly on the use of sulfuric acid for produce phosphoric acid from natural phosphate rock according to the following reaction:

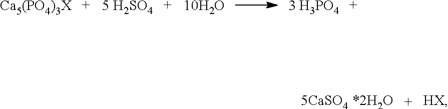

whereby X=F, Cl or OH.

However, this technology results in the generation of large amounts of the byproduct calcium sulphate, so-called phosphorus gypsum or phosphogypsum that represents disposal and environmental problems. About 33 million tons of gypsum are produced at phosphoric acid plants in the United States each year. So far, this by-product so far has usually been sent to landfill, where it is present as a hydrate (CaSO₄*2H₂O), whereby about 330 million tons are contained in existing stockpiles.

The landfilling of hydrate is problematic in terms of environmental pollution potential because it reacts with water and the dissolved sulphate (SO₄²⁻) can enter the leachate, resulting in a direct discharge into the groundwater and surface waters. Moreover, the phosphogypsum from the fertilizer industry also poses the additional problem that the used natural phosphate rocks carry a lot of impurities, depending on where they are quarried. If the gypsum residues stored in the landfill are partially dissolved, these impurities will additionally contaminate the environment.

In detail, phosphogypsum is very often radioactive due to the presence of naturally occurring uranium (5-10 ppm) and thorium, and their daughter nuclides radium, radon, polonium, etc. Amongst all, Uranium is concentrated during the formation of evaporite deposit. Other components of phosphogypsum include typically 5 to 25 wt.-% silica, up to 2 wt.-% fluoride, up to 10 wt.-% phosphorus, up to 0.8 wt.-% iron (Fe, ˜0.8%), up to 1.5 wt.-% aluminum, up to 20 ppm lead (Pb, −20 ppm), and up to 35 ppm cadmium (Cd, ˜0.35 ppm).

There are first investigations on how to recycle the so-called phospogypsum, like gypsum from the construction industry. In this context, WO 2021/140075 describes how clinker can be made from it for the construction industry.

However, due to the described contaminations, the current landfill residues of phosphogypsum require a proportionally much greater post-treatment than is ecologically reasonable for the construction industry. Furthermore, these recycling processes have the disadvantage of being comparatively energy-intensive and thus prevent the above-mentioned requirements regarding the ecological footprint at the expense of a comparably high CO₂ emission.

Therefore, the present invention is based on the task of providing a process in which phosphogypsum can be converted in such a way that the hitherto existing hazards of water pollution due to the landfilling of this material can be reliably avoided and, at the same time, the overall sustainability of the process can be ensured. This task is solved by a process with the features of claim 1.

Such a process for the permanent deposition of phosphogypsum with simultaneous permanent carbon dioxide sequestration, comprises the following steps
i. decomposition of calcium sulfate contained in the phosphogypsum with hydrogen to calcium oxide, sulfur dioxide and water at temperatures between 1.00° and 1.400° C., preferably 1.100 to 1.350° C., whereby a gas stream containing the sulfur dioxide and the water and a solid stream containing the produced calcium oxide result,
ii. production of sulfuric acid, whereby the sulfur dioxide contained in the gas stream obtained in step is utilized (i),
iii. carbonization of the calcium oxide contained in the solid stream with carbon dioxide to a calcium carbonate at temperatures between 50° and 800° C., preferably 600 to 750° C. in order to obtain a solid material and
iv. deposition of the solid material from step (iii).

Thereby, the phosphogypsum is first treated with hydrogen to produce calcium oxide:

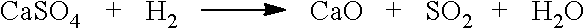

in the decomposition step (i). In the following step (iii) it is then converted to the relating carbonate

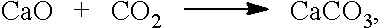

which enables the additional fixation of CO₂. Particularly the fixation of carbon dioxide minimizing the climate impact of the overall process.

As one of the main targets, the phosphogypsum is transferred from a dissolvable by-product into calcium carbonate, which is almost insoluble in water (0.014 g/I at 20° C.).

As another positive impact, density of CaCO₃ is with a value of 2,71 g/cm3 significantly higher than from the relating sulfate (2,32 g/cm3). As the molar mass of CaCO₃ is 100,0869 g/mol while it is 136.14 g/mol for CaSO₄ and the amount of calcium in the specific compound is 40,04% for CaCO₃ and 29,44% for CaSO₄, 0,0108 mol/cm³ Ca can be stored in a carbonate, while for the sulphate this value is only about 0,005 mol/cm³. The required landfill volume can therefore be reduced to just under half. This results in another advantage besides the insolubility of the material.

Beside this, the SO₂-containing off-gases from the decomposition in step (i) are converted to sulfuric acid by first oxidizing the sulfur dioxide to sulfur trioxide and then absorbing the sulfur trioxide in sulfuric acid with water. Sulfuric acid is a value product which can be used in variety of chemical processes.

Fertilizer production is the primary source for phosphogypsum, which is why a coupling of the process according to the invention is favorable. In this context, it is particularly preferred to use the sulfuric acid in a fertilizer production so that the acid loop is closed.

Moreover, in a very preferred embodiment, a cleaning step is foreseen to purify the gas stream resulting from step (i) before it is converted to sulfuric acid in step (ii). As the easiest form of gas cleaning, the gas can be cooled such that contained water is condensed and removed as a liquid. In addition, or alternatively, contained solids are removed, e.g. in a filter or a venturi scrubber. Moreover, a lot of impurities, particularly arsenic, cadmium and lead as well as fluoride can be removed in very well-known cleaning steps being common knowledge for the sulfuric acid production. Such a gas cleaning can be tailored to the specific impurities contained in the phosphogypsum depending on the used raw material. Dues to the gas cleaning, the resulting sulfuric acid features a very high purity level.

Moreover, to increase the overall positive ecological impact, it is necessary to have a smart system of energy consumption. In this context, it is preferred that the phosphogypsum, the hydrogen and/or the air for the decomposition in step (i) is/are heated with energy obtained in a cooling of the gas stream resulting from step (i). Such a heating can be directly or indirectly. Moreover, it is also possible to use recycled energy from the gas cooling for decomposing in step (i) itself.

In addition, or alternatively, it is also possible to heat the same mass streams, namely the phosphogypsum, the hydrogen and/or the air for the decomposition in step (i) directly or indirectly with energy obtained in a cooling of the solid stream resulting from step (i). Naturally, also a re-use of said energy is possible in the decomposing in step (i) itself is/are heated.

As a further possibility for recycling energy, energy can be obtained by cooling the calcium carbonate resulting from step (iii). Also, said energy can be used for direct or indirect heating of the phosphogypsum, the hydrogen and/or the air for the decomposition in step (i) and/or the decomposing in step (i) itself.

Furthermore, the process becomes even more environmentally friendly when additional energy is obtained via solar energy.

Nevertheless, the necessary relatively high temperature needed in the decomposition reactor requires specific forms of final heating, particularly burning a fuel inside of the reactor.

In this context, the environmental friendliness is increased by using a fuel, which is reducing or even avoiding emission of CO₂. This holds particularly true e.g., for methanol. Hydrogen is particularly preferred, because it also used as an educt in the decomposition.

The use of so-called green hydrogen leads to an even better ecological balance. Green hydrogen is a clean energy source that only emits water vapor. In particularly, such green hydrogen is produced by the electrolysis of water. In an even more preferred option, renewable energy is used to power the electrolysis, amongst all solar power, but other CO₂-lean sources for the electrical energy like hydro- wind- or nuclear power are possible.

In addition, it is possible to use energy obtained in any of the steps (i), (iii) or (iv), particularly in the cooling of the solid streams, in the sulfuric acid production in step (ii). Thereby, it can be used to re-heat the SO₂ stream previous to the feeding into the converter. Additionally, or alternatively, the energy obtained in the catalytic oxidation of SO₂ to form SO₃ can also be combined with the above-discussed energy from any of the other process steps. Thereby, it is possible to produce steam which can then be converted into electrical energy in a known way by means of a turbo alternator.

Moreover, the invention also covers a plant for producing a material for the permanent deposition of phosphogypsum with simultaneous permanent carbon dioxide sequestration with the features of claim 14. Such a plant is suitable for a process with the features of any of claims 1 to 13.

It comprises a decomposition reactor for a decomposition of calcium sulfate contained in the phosphogypsum with hydrogen to calcium oxide, sulfur dioxide and water, whereby a gas stream containing the sulfur dioxide and the water and a solid stream containing the produced calcium oxide result.

Furthermore, a production unit for sulfuric acid is foreseen. Therein the sulfur dioxide contained in the gas stream obtained in step (i) is converted to sulfuric acid by first oxidizing the sulfur dioxide to sulfur trioxide in at least one converter and then the sulfur trioxide is absorbed in sulfuric acid with water in at least one absorber.

Finally, such a plant contains a carbonization reactor for a carbonization of the calcium oxide contained in the solid stream with carbon dioxide to a calcium carbonate at temperatures. Therein, a solid material produced being suitable for a permanent deposition.

Such a plant allows the dissolution or avoidance of landfills for phosphogypsum and is simultaneously able to absorb carbon dioxide.

Moreover, a counter flow reactor is particularly preferred for the decomposition and/or the carbonization reactor as it enables a very intensive contact between the reactants. Thereby, the solids are streaming in opposite direction of the hydrogen and/or the carbon dioxide.

Further objectives, features, advantages, and possible applications of the invention can also be taken from the following description of the attached figure and the example. All features described and/or illustrated form the subject matter of the invention per se or in any combination, independent of their inclusion in the individual claims or their back-references.

In the drawings:

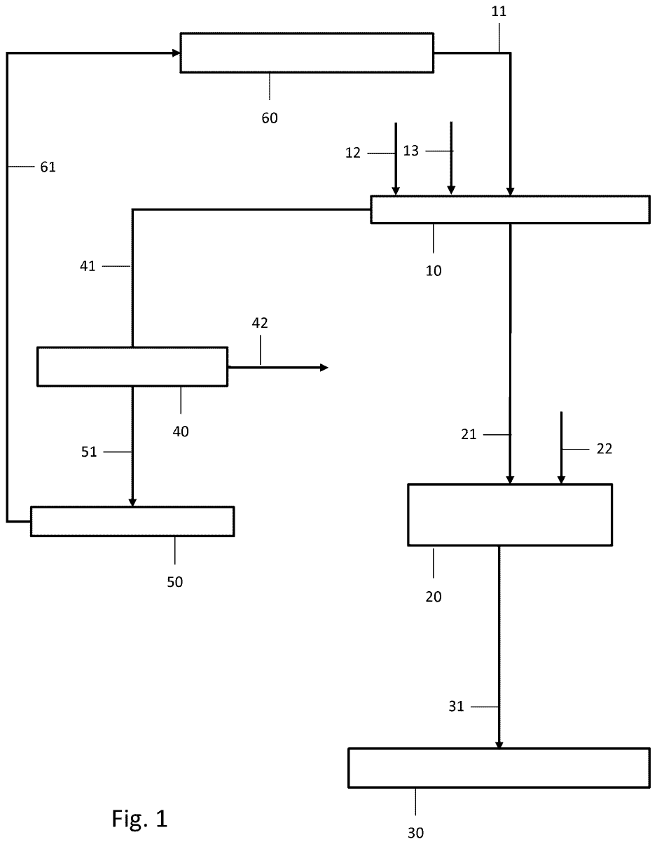

FIG. 1 shows a schematic view of the inventive process,

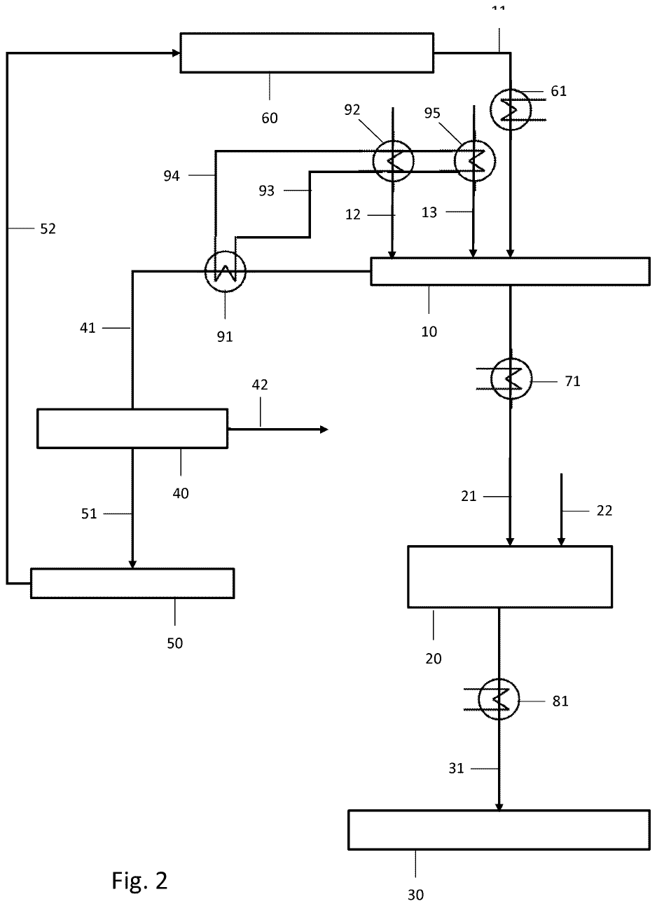

FIG. 2 shows a schematic view of the inventive process with indirect heat recycling and

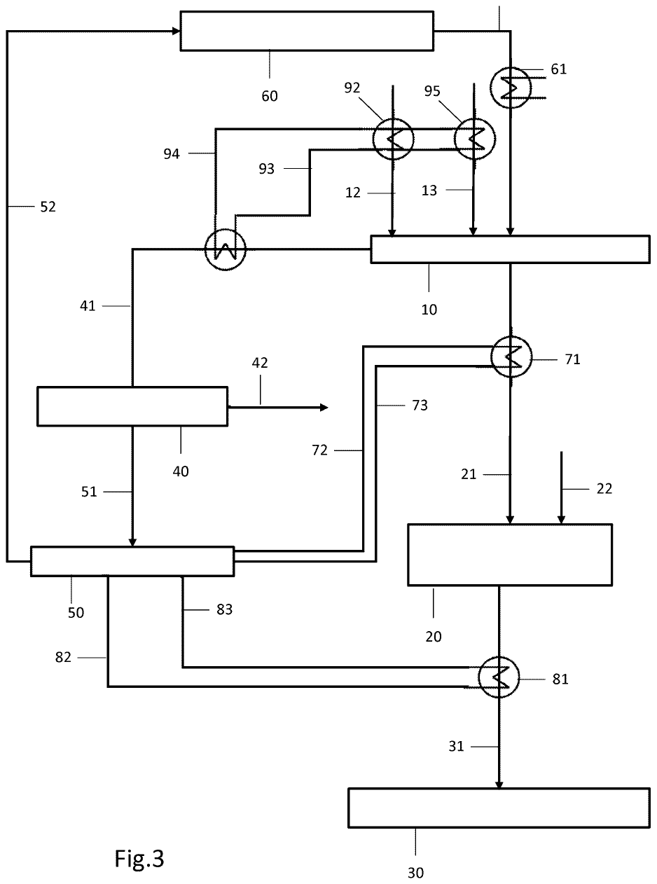

FIG. 3 shows a schematic view of the inventive process with direct heat recycling.

FIG. 1 shows the basic process of the current invention. Example values are given for mass streams and temperatures, which however, should not be understood as being limiting but just for a better understanding.

In detail, phosphogypsum is fed into a decomposition reactor 10 via line 11. As an example, a mass flow of 125 t/h CaSO₄*2 H₂O is assumed.

The solid material introduced via line 11 can come directly from a fertilizer production 60 or from an already existing landfill. This makes it possible to dissolve landfills already polluting soil waters and convert these depositions into harmless solids.

In the decomposition reactor 10, the material is reacted with hydrogen from line 12 to form calcium oxide, sulfur dioxide and water at temperatures of e.g., about 1300° C. Favorably, in this reactor the solid material is fed in countercurrent to hydrogen. In addition, it is advisable to carry out the reaction in the presence of air. In this example, 2 t/hour hydrogen are injected.

The given example value would also be sufficient to use hydrogen also for heating the decomposition reactor 10. However, it is also possible to use another, preferable a renewable fuel for heating, which has to be injected via a not-shown line. In any case, it is necessary to introduce air via line 13 for the burning of hydrogen or fuel.

The resulting waste gases are extracted via line 41, while the calcium oxide produced, together with all solid impurities, is fed via lines 21 to the carbonization reactor 20. A mass flow of 51.5 t/hour solid material results for the given values.

In the carbonization reactor 20, CO₂ is also introduced into this reactor via line 22. Due to the reaction taking place, calcium carbonate is formed here, e.g., at reaction temperatures of about 720° C.

Thus, it is possible not only to convert the calcium sulfate into calcium carbonate but also to store carbon dioxide. For the given data, a mass flow of 39.6 t/h CO₂ can be absorbed. This carbon dioxide can, for example, come from another area of fertilizer production, but also from a completely different process.

Moreover, calcium carbonate is much more densely packed and thus smaller in terms of the required landfill volume. Compared to the amount of 125 t/h of calcium sulphate used, 91.1 t/h calcium carbonate is produced. This corresponds to a reduction in the mass flow of about 25%.

This solid material from the carbonization reactor 20 is fed to deposition 30 via line 31.

With the mass flows of the shown example, the mass flow of the off gases in line 41 is 200 t/h. The waste gas flow in line 41 can optionally be fed to a gas cleaning system 40. However, for some compositions, it is also possible to feed the gas stream to a sulfuric acid production system 50 via lines 41 and 51 directly. With the mass flows of the shown example, the mass flow of the waste gas is 200 t/h.

If gas cleaning 40 is foreseen, this can be carried out at 400° C., for example. This produces, on the one hand, solid residues that can be separated at these lower temperatures, such as arsenic, cadmium and lead. In the current example, their mass flow would be around of 1 to 5 t/h and, on the other hand, waste gases that are so harmless in their composition that they can be discharged into the atmosphere via line 42.

For this example, the remaining mass flow of sulfur dioxide would be 58.6 t/hour. It is directed to a sulfuric acid production 50. In most designs but not limiting, the sulfur dioxide to in is catalytically oxidized in at least one converter to sulfur trioxide. This is a highly exothermic process, so very often different catalyst stages are used, and cooling is provided between each catalyst stage. Heat generated there can be reused elsewhere in the process.

Subsequently, the sulfur trioxide is absorbed in sulfuric acid with a small amount of water, resulting in highly concentrated sulfuric acid. This can optionally also be at least partially returned to fertilizer production 60 via line 52, as typically sulfuric acid is used to convert phosphate-containing rock in such a way that phosphate compounds are produced which are used as fertilizer. Similarly, it is also conceivable to discharge sulfuric acid at least partially from sulfur production 50 for other uses.

In principle, it is conceivable to use solar energy for various types of preheating. In particular this concerns the preheating of the hydrogen in line 12 and/or the preheating of the solid in line 11.

In addition, to avoid carbon dioxide emissions, the heating of the decomposition reactor 10 to the very high operating temperatures can be done by using hydrogen as fuel. In the given example, an overall amount of 2.6 t/h hydrogen would be required is hydrogen is both used as a fuel and as an educt.

The ecological footprint of the process can be further improved by this hydrogen as well as the hydrogen supplied to the line 12 being so-called green hydrogen. Green hydrogen is hydrogen that has been produced CO₂-free. This is usually done by electrolysis of water, using renewable energy sources to generate the required electricity.

FIG. 2 shows several possibilities of additional heat recovery within the process, all using indirect heat transfer. All shown options can be realized separately or in combination with any of the designs presented in FIG. 2 or 3.

Typically, a pre-heating of the solid stream is foreseen using a heat-exchanger 61. To increase energy efficiency of the process, the solid material in line 21 is cooled via heat exchanger 71. Resulting energy can be used in any other part of the plant for heating or also for generating steam to produce electricity.

In addition, or alternatively, a heat exchanger 81 is also provided in line 31 for heat recovery from the solid calcium carbonate. Energy obtained therein can be used similarly to energy from heat exchanger 71.

A third heat recovery can be provided in the exhaust gas flow in line 41. Therein, a heat exchanger 91 can be placed. Here, a heat transfer medium would be brought into the heat exchanger 92 and/or heat exchanger 95 via line 93, which is used in line 12, to preheat hydrogen and/or air fed into the decomposition reactor 10. Here, too, the heat transfer medium is recirculated after passing heat exchanger 95, namely via line 94. Even though FIG. 2 shows a series connection, it is also possible to connect the two heat exchangers 92 and 95 in parallel or to preheat only one of the two streams.

Finally, FIG. 3 concentrates on the use in the sulfuric acid plant.

In detail, the heat exchanger 71 in line 21 and/or the heat exchanger 81 are coupled via line 72 and 73 or 82 and 83 with the sulfuric acid production 50 to be used for the pre-heating of sulfur dioxide and/or to be used to produce steam, as it is typically foreseen between the separate stages of the exothermic catalytic oxidation. The additional amount of oxygen enables an increasing of the quantity and/or the quality of the produced steam, which is usually forwarded to a turbine for producing electricity.

### LIST OF REFERENCES

10 decomposition reactor
11-13 line
20 carbonization reactor
21,22 line
30 deposition
31 line
40 gas cleaning
41,42 line
50 sulfuric acid production
51,52 line
60 fertilizer production
61 line
71 heat exchanger
72, 73 line
81 heat exchanger
82, 83 line
91 line
92,95 heat exchanger
93, 94 line

1.-14. (canceled)

15. A process for the permanent deposition of phosphogypsum with simultaneous permanent carbon dioxide sequestration, comprising the following steps:
i. decomposition of calcium sulfate contained in the phosphogypsum with hydrogen to calcium oxide, sulfur dioxide and water at temperatures between 1.00° and 1.400° C., whereby a gas stream containing the sulfur dioxide and the water and a solid stream containing the produced calcium oxide result,
ii. production of sulfuric acid, whereby the sulfur dioxide contained in the gas stream obtained in step (i) is converted to sulfuric acid,
iii. carbonization of the calcium oxide contained in the solid stream with carbon dioxide to a calcium carbonate at temperatures between 50° and 800° C. in order to obtain a solid material and
iv. deposition of the solid material from step (iii).

16. The process according to claim 15, wherein the phosphogypsum results from a fertilizer production.

17. The process according to claim 15, wherein a cleaning step is foreseen to purify the gas stream resulting from step (i) before it is converted to sulfuric acid in step (ii).

18. The process according to claim 16, wherein at least parts of the sulfuric acid are recirculated into the fertilizer production, where it is used as a reaction compound.

19. The process according to claim 15, wherein the phosphogypsum, the hydrogen and/or the air for the decomposition in step (i) and/or the decomposing in step (i) itself is/are heated directly or indirectly with energy obtained in a cooling of the gas stream resulting from step (i).

20. The process according to claim 15, wherein the phosphogypsum, the hydrogen and/or the air for the decomposition in step (i) and/or the decomposing in step (i) itself is/are heated directly or indirectly with energy obtained in a cooling of the solid stream resulting from step (i).

21. The process according to claim 15, wherein the phosphogypsum, the hydrogen and/or the air for the decomposition in step (i) and/or the decomposing in step (i) itself is/are heated directly or indirectly with energy obtained in a cooling of the solid material resulting from step (iii).

22. The process according to claim 15, wherein the phosphogypsum, the hydrogen and/or the air for the decomposition in step (i) and/or the decomposing in step (i) itself is/are heated directly or indirectly with energy obtained via solar energy.

23. The process according to claim 15, wherein the decomposition in step (i) itself is heated directly or indirectly with energy obtained in combustion of hydrogen or with a renewable fuel.

24. The process according to claim 15, wherein carbon dioxide is preheated and/or the carbonization in step (iii) directly or indirectly with energy obtained in a cooling of the solid material or off-gases resulting from step (iii).

25. The process according to claim 15, wherein energy obtained in a cooling of the gas stream resulting from step (i), in a cooling of the solid stream resulting from step (i), in a cooling of the solid material resulting from step (iii) and/or in a cooling of the solid material or off-gases resulting from step (iii) is used in the sulfuric acid production.

26. The process according to claim 15, wherein the hydrogen used as a reaction compound in step (i) and/or for the combustion of hydrogen is green hydrogen.

27. A plant for producing a material for the permanent deposition of phosphogypsum with simultaneous permanent carbon dioxide sequestration, comprising:
a decomposition reactor for a decomposition of calcium sulfate contained in the phosphogypsum with hydrogen to calcium oxide, sulfur dioxide and water, whereby a gas stream containing the sulfur dioxide and the water and a solid stream containing the produced calcium oxide result,
a production unit for sulfuric acid, whereby the sulfur dioxide contained in the gas stream obtained in step (i) is converted to sulfuric acid, and
a carbonization reactor for a carbonization of the calcium oxide contained in the solid stream with carbon dioxide to a calcium carbonate at temperatures between 50° and 800° C. in order to obtain a solid material for a permanent deposition.

28. The plant according to claim 27, wherein the decomposition reactor and/or the carbonization reactor is/are a counter current flow reactor.
